(19) United States
(12) Patent Application Publication
(10) Pub. No.: US 2024/0343878 A1
(43) Pub. Date: Oct. 17, 2024

(54) POLYBENZOXAZINE AEROGEL FILM AND PREPARATION METHOD THEREOF

(71) Applicant: Shijiazhuang Tiedao University, Shijiazhuang (CN)

(72) Inventors: Guoqiang QIN, Shijiazhuang (CN); Muyang ZHAO, Shijiazhuang (CN); Ao WANG, Shijiazhuang (CN); Ziyuan ZHAO, Shijiazhuang (CN); Guanglei ZHANG, Shijiazhuang (CN); Hongya WU, Shijiazhuang (CN)

(21) Appl. No.: 18/401,804

(22) Filed: Jan. 2, 2024

(30) Foreign Application Priority Data
Apr. 11, 2023 (CN) 202310378947.5

(51) Int. Cl. C08J 9/28; C08J 5/18

(52) U.S. Cl. CPC C08J 9/28; C08J 5/18; C08J 2205/026; C08J 2379/04

(57) ABSTRACT

A polybenzoxazine aerogel film and a preparation method thereof are provided in the present disclosure, belonging to the field of preparation of aerogel film composite material. The preparation method of the polybenzoxazine aerogel film includes the following steps: dissolving benzoxazine monomer in a solvent and catalyzing to obtain a polybenzoxazine solution; coating the polybenzoxazine solution as a wet gel film; and aging and drying the wet gel film to obtain the polybenzoxazine aerogel film.

### CROSS-REFERENCE TO RELATED APPLICATIONS

This application claims priority to Chinese Patent Application No. 202310378947.5, filed on Apr. 11, 2023, the contents of which are hereby incorporated by reference.

### TECHNICAL FIELD

The present disclosure relates to the field of preparing aerogel film composite materials, and in particular to a polybenzoxazine aerogel film and a preparation method thereof.

### BACKGROUND

Owing to the properties of low density, low thermal conductivity and good acoustic performance, aerogels have been widely used in civil, industrial and military fields. The technique of preparing organic aerogels from phenolic resins has developed gradually, such as polybenzoxazine polymer aerogels prepared from new phenolic resins synthesized using polybenzoxazine, with good self-extinguishing property, high porosity, low density and excellent mechanical properties.

However, recent studies have found that the performance of polybenzoxazine aerogels is affected by preparation conditions, such as drying and cleaning, which lead to inferior specific surface area, porosity, thermal conducting efficiency, and other properties, as well as the inability to be applied to a wide variety of application scenarios, making the promotion of polybenzoxazine aerogels limited, so further improvements are still needed.

### SUMMARY

It is an objective of the present disclosure to provide a polybenzoxazine aerogel film and a preparation method thereof. According to the present disclosure, polybenzoxazine aerogels are combined with thin film materials, and the preparation method is optimized, so that the polybenzoxazine aerogels may be widely applied in the field of thermal insulation.

In order to achieve the above objectives, the present disclosure provides the following technical schemes.

One of the technical schemes of the present disclosure provides a preparation method of a polybenzoxazine aerogel film, including following steps:
(1) dissolving benzoxazine monomer in a solvent and catalyzing to obtain a polybenzoxazine solution;
(2) coating the polybenzoxazine solution as a wet gel film; and
(3) aging and drying the wet gel film to obtain the polybenzoxazine aerogel film.

Optionally, in step (1), an addition amount of the benzoxazine monomer is 10-50 parts by mass, an addition amount of the solvent is 20-200 parts by mass; the catalyzing includes acid catalysis or thermal catalysis; the thermal catalysis includes heating at 120-200 degrees Celsius (C) for 100-150 hours (h), and the acid catalysis includes dissolving 0.5-20 parts by mass of catalyst in a solvent and then pouring into a solution then pouring into a solution dissolved with the benzoxazine monomer, where the catalyst is hydrochloric acid.

Optionally, the addition amount of the benzoxazine monomer is 15-40 parts by mass, the addition amount of the solvent is 30-150 parts by mass, and an addition amount of the catalyst is 0.5-5 parts by mass.

Optionally, in the step (1), a preparation method of the benzoxazine monomer includes: adding N,N-Dimethylformamide (DMF) and bisphenol F into formaldehyde at 45° C., heating to 80° C. after complete dissolution, adding aniline for reaction for 5 b, and finally washing with NaOH solution and ethanol to obtain the benzoxazine monomer.

Optionally, a preparation method of the wet gel film in step (2) includes: coating the polybenzoxazine solution onto a substrate, where a process of the coating includes a spin coating method, a brush coating method, a dip coating method or a roll coating method, and the substrate is ceramic, metal or organic.

Optionally, in the step (2), after the coating is completed, a standing step is further included, with a standing duration of 10-300 minutes (min).

Optionally, in step (3), an aging temperature is 25° C. and a duration is 0.5-12 h.

Optionally, in the step (3), after the aging is completed, a step of cleaning is also included, where the cleaning includes washing with an organic solvent A, an organic solvent B, an organic modifier and an organic solvent C in turn for three times, each time for 8-16 h; the organic solvent A is DMF, the organic solvent B is acetone, the organic solvent C is N-pentane, and the organic modifier is acetonitrile.

Optionally, in the step (3), the drying is supercritical drying, freeze drying, micro-positive pressure drying or normal pressure drying; a drying medium of the supercritical drying is ethanol or CO₂: a temperature of the freeze drying is −80° C. to −20° C.; a pressure of the micro-positive pressure drying is 200-400 pascals (Pa) higher than an atmospheric pressure, with a temperature of 10-300° C.; and a temperature of the normal pressure drying is 100-300° C.; after the drying is completed, a temperature treatment is required, with a temperature treatment condition of 60-300° C.

Another technical scheme of the present disclosure provides a polybenzoxazine aerogel film obtained by the preparation method.

Another technical scheme of the present disclosure provides an application of the polybenzoxazine aerogel film in a field of thermal insulation.

Cleaning is one of the important conditions for the preparation of benzoxazine aerogels. In the cleaning process of the present disclosure, DMF solution is firstly adopted, so that the oxazine ring in the wet gel is fully open polymerized to form a more complex cross-linked structure, the reaction is more sufficient, and the newly formed benzoxazine skeleton structure is reinforced; afterwards, the wet gel is placed into the acetone solution, which is highly volatile with a low boiling point, and is capable of displacing the residual solution in the wet gel to facilitate the drying of the wet gel, so that the wet gel are further improved in terms of mechanical properties, transforming from an elastic solid to a plastic solid; the wet gel is then placed into the acetonitrile solution, which acts as an organic modifier and extractant and reacts with the amine groups to strengthen the skeleton structure of the wet gel; finally, the wet gel is placed into N-pentane to remove the impurities, such as alcohols and water, so that the network structure of the gel film is more stable and the gel drying is facilitated.

The beneficial technical effects of the present disclosure are as follows: using benzoxazine monomers as raw materials, the polybenzoxazine aerogel film of the present invention is prepared by heat-catalysed or acid-catalysed polymerisation, followed by a film-coating process to prepare the film, and drying by methods of supercritical, freeze-drying, micro-positive pressure or normal pressure: the preparation method of the aerogel film is simple, allowing for continuous production on a large scale; and the prepared composite aerogel film has excellent mechanical properties and thermal insulation properties.

The polybenzoxazine aerogel film prepared by the present disclosure not only has excellent properties such as light weight, high strength, high hydrophobicity, high flame retardancy and the like, but also has the advantages of simple and convenient preparation process, suitability for industrial production and the like, making it more suitable for the field of thermal insulation and of good application value.

### BRIEF DESCRIPTION OF THE DRAWINGS

FIG. 1 shows a pore size distribution of polybenzoxazine aerogel films obtained in Embodiments 1-5.

FIG. 2 shows thermal conductivity curves of polybenzoxazine aerogel films obtained at different heat treatment temperatures.

FIG. 3 is a process of preparing a polybenzoxazine aerogel film provided in an embodiment of the present disclosure.

### DETAILED DESCRIPTION OF THE EMBODIMENTS

Various exemplary embodiments of the present disclosure are now described in detail, which detailed description should not be considered as a limitation of the present disclosure, but should be understood as a more detailed description of certain aspects, characteristics and embodiments of the present disclosure. It should be understood that the terminology described in the present disclosure is only for describing specific embodiments and is not used to limit the present disclosure.

In addition, for the numerical range in the present disclosure, it should be understood that each intermediate value between the upper limit and the lower limit of the range is also specifically disclosed. Intermediate values within any stated value or stated range, as well as each smaller range between any other stated value or intermediate values within the stated range are also included in the present disclosure. The upper and lower limits of these smaller ranges can be independently included or excluded from the range.

Unless otherwise specified, all technical and scientific terms used herein have the same meaning as commonly understood by one of ordinary skill in the art to which this present disclosure relates. Although the present disclosure only describes the preferred methods and materials, any methods and materials similar or equivalent to those described herein can also be used in the practice or testing of the present disclosure.

The terms “including”, “comprising”, “having” and “containing” used in this specification are all open terms, which means including but not limited to.

The raw materials used in the following embodiments and comparative embodiments of the present disclosure are all commercially available products.

The hydrochloric acid used in the following embodiments and comparative embodiments of the present disclosure is 37% hydrochloric acid by mass.

The preparation method of the benzoxazine monomer used in the following embodiments and comparative embodiments of the present disclosure is as follows:
at 45 degrees Celsius (° C.), 100 parts by mass of N,N-dimethylformamide (DMF) and 100 parts by mass of bisphenol F are added into 60 parts by mass of formaldehyde, followed by complete dissolution and heating to 80° C., and then 75 parts by mass of aniline are added to react for 5 h, and finally the benzoxazine monomer is obtained after washing with NaOH solution and ethanol for 3 h. The structural formula of the benzoxazine monomer is as follows:

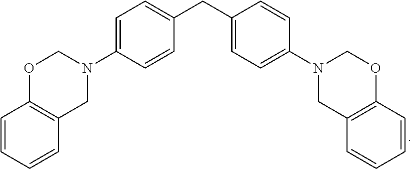 [SMILES: c1ccc2c(c1)CN(c1ccc(Cc3ccc(N4COc5ccccc5C4)cc3)cc1)CO2]

### Embodiment 1

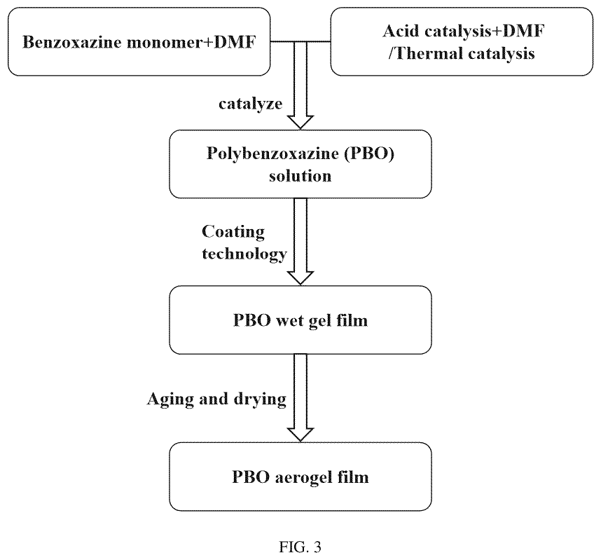

Preparation of polybenzoxazine aerogel film (with a process as shown in FIG. 3):
(1) 20 parts by mass of benzoxazine monomer are dissolved with 42 parts by mass of DMF, 3 parts by mass of hydrochloric acid are dissolved with 42 parts by mass of DMF, and then the two solutions are mixed homogeneously to obtain a polybenzoxazine solution;
(2) the polybenzoxazine solution is coated onto a ceramic substrate with a thickness of 3 millimeters (mm) by a spin coating method, and a wet gel film is developed after standing for 30 min; and
(3) the wet gel film is aged at 20° C. for 6 h, and subjected to sequential washing with DMF, acetone, acetonitrile and N-pentane for 3 times, each time for 8 h, followed by drying at 25° C. under normal pressure, and a temperature treatment at 25° C. for 2 h, and the polybenzoxazine aerogel film is obtained.

### Embodiment 2

Preparation of polybenzoxazine aerogel film:
(1) 20 parts by mass of benzoxazine monomer coupled with 42 parts by mass of DMF are dissolved, 3 parts by mass of hydrochloric acid are dissolved with 42 parts by mass of DMF, and then the two solutions are mixed homogeneously, and a polybenzoxazine solution is obtained after the reaction is completed;
(2) the polybenzoxazine solution is coated onto a ceramic substrate with a thickness of 3 mm by a spin coating method, and a wet gel film is developed after standing for 30 min; and
(3) the wet gel film is aged at 20° C. for 6 h, and the aged wet gel film is subjected to fully washing with DMF, acetone, acetonitrile and N-pentane in turn for 3 times, each time for 8 h, followed by drying at 25° C. under normal pressure, and a temperature treatment at 120° C. for 2 h, and the polybenzoxazine aerogel film is obtained.

### Embodiment 3

Preparation of polybenzoxazine aerogel film:
(1) 20 parts by mass of benzoxazine monomer coupled with 42 parts by mass of DMF are dissolved, 3 parts by mass of hydrochloric acid are dissolved with 42 parts by mass of DMF, and then the two solutions are mixed homogeneously, and a polybenzoxazine solution is obtained after the reaction is completed;
(2) the polybenzoxazine solution is coated onto a ceramic substrate with a thickness of 3 mm by a spin coating method, and a wet gel film is developed after standing for 30 min; and
(3) the wet gel film is aged at 20° C. for 6 h, and the aged wet gel film is subjected to fully washing with DMF, acetone, acetonitrile and N-pentane in turn for 3 times, each time for 8 h, followed by supercritical drying with ethanol to obtain the polybenzoxazine aerogel film.

### Embodiment 4

Preparation of polybenzoxazine aerogel film:
(1) 20 parts by mass of benzoxazine monomer coupled with 42 parts by mass of DMF are dissolved, 3 parts by mass of hydrochloric acid are dissolved with 42 parts by mass of DMF, and then the two solutions are mixed homogeneously, and a polybenzoxazine solution is obtained after the reaction is completed;
(2) the polybenzoxazine solution is coated onto a ceramic substrate with a thickness of 3 mm by a spin coating method, and a wet gel film is developed after standing for 30 min; and
(3) the wet gel film is aged at 20° C. for 6 h, and the aged wet gel film is subjected to fully washing with DMF, acetone, acetonitrile and N-pentane in turn for 3 times, each time for 8 h, followed by freeze-drying at −60° C. and a temperature treatment at 180° C. for 2 h to obtain the polybenzoxazine aerogel film.

### Embodiment 5

Preparation of polybenzoxazine aerogel film:
(1) 20 parts by mass of benzoxazine monomer coupled with 42 parts by mass of DMF are dissolved, 3 parts by mass of hydrochloric acid are dissolved with 42 parts by mass of DMF, and then the two solutions are mixed homogeneously, and a polybenzoxazine solution is obtained after the reaction is completed;
(2) the polybenzoxazine solution is coated onto a ceramic substrate with a thickness of 3 mm by a spin coating method, and a wet gel film is developed after standing for 30 min; and
(3) the wet gel film is aged at 20° C. for 6 h, and the aged wet gel film is subjected to fully washing with DMF, acetone, acetonitrile and N-pentane in turn for 3 times, each time for 8 h, followed by drying at 25° C. under a micro-positive pressure of 0.5 KPa and a temperature treatment at 200° C. for 2 h to obtain the polybenzoxazine aerogel film.

### Embodiment 6

Preparation of polybenzoxazine aerogel film:
(1) 10 parts by mass of benzoxazine monomer coupled with 100 parts by mass of DMF are dissolved, 0.5 part by mass of hydrochloric acid are dissolved with 100 parts by mass of DMF, and then the two solutions are mixed homogeneously, and a polybenzoxazine solution is obtained after the reaction is completed;
(2) the polybenzoxazine solution is coated onto a ceramic substrate with a thickness of 3 mm by a spin coating method, and a wet gel film is developed after standing for 10 min; and
(3) the wet gel film is aged at 20° C. for 6 h, and subjected to sequential washing with DMF, acetone, acetonitrile and N-pentane for 3 times, each time for 8 h, followed by drying at 100° C. under normal pressure and a temperature treatment at 200° C. for 2 h to obtain the polybenzoxazine aerogel film.

### Comparative Embodiment 1

Preparation of polybenzoxazine aerogel film:
(1) 20 parts by mass of benzoxazine monomer coupled with 42 parts by mass of DMF are dissolved, 3 parts by mass of hydrochloric acid are dissolved with 42 parts by mass of DMF, and then the two solutions are mixed homogeneously, and a polybenzoxazine solution is obtained after the reaction is completed;
(2) the polybenzoxazine solution is coated onto a ceramic substrate with a thickness of 3 mm by a spin coating method, and a wet gel film is developed after standing for 30 min; and
(3) the wet gel film is aged at 20° C. for 6 h, and subjected to no washing treatment, followed by drying at 25° C. under normal pressure and a temperature treatment at 25° C. for 2 h to obtain the polybenzoxazine aerogel film.

This comparative embodiment demonstrates the effect of cleaning, without solvent cleaning of DMF, acetone, and N-pentane and the cleaning of acetonitrile modifier, the reaction in the aerogel is not carried out thoroughly and impurities are existed, which leads to the instability of the internal skeleton structure of the aerogel and the serious degradation of the performance.

### Comparative Embodiment 2

Preparation of polybenzoxazine aerogel film:
(1) 20 parts by mass of benzoxazine monomer coupled with 42 parts by mass of DMF are dissolved, 3 parts by mass of hydrochloric acid are dissolved with 42 parts by mass of DMF, and then the two solutions are mixed homogeneously, and a polybenzoxazine solution is obtained after the reaction is completed;
(2) the polybenzoxazine solution is coated onto a ceramic substrate with a thickness of 3 mm by a spin coating method, and a wet gel film is developed after standing for 30 min; and
(3) the wet gel film is aged at 20° C. for 6 h, and the aged wet gel film is subjected to fully washing with DMF, acetone, acetonitrile and N-pentane in turn for 3 times, each time for 8 h, followed by drying at 25° C. under normal pressure and a temperature treatment at 25° C. for 2 h to obtain the polybenzoxazine aerogel film.

This comparative embodiment illustrates the effect of acetonitrile as a modifier in cleaning. Acetonitrile is reactive with the amine groups in the aerogel to strengthen the skeleton structure of the wet gel, and the cleaning without acetonitrile makes the internal skeleton structure in the aerogel unstable, and the performance decreases.

### Comparative Embodiment 3

Preparation of polybenzoxazine aerogel film:
(1) 20 parts by mass of benzoxazine monomer coupled with 42 parts by mass of DMF are dissolved, 3 parts by mass of hydrochloric acid are dissolved with 42 parts by mass of DMF, and then the two solutions are mixed homogeneously, and a polybenzoxazine solution is obtained after the reaction is completed;
(2) the polybenzoxazine solution is coated onto a ceramic substrate with a thickness of 3 mm by a spin coating method, and a wet gel film is developed after standing for 30 min; and
(3) the wet gel film is aged at 20° C. for 6 h, and the aged wet gel film is subjected to fully washing with acetonitrile and N-pentane in turn for 3 times, each time for 8 h, followed by drying at 25° C.′ under normal pressure and a temperature treatment at 25° C. for 2 h to obtain the polybenzoxazine aerogel film.

The effect of solvents in the cleaning process is demonstrated by this comparative embodiment, where the cleaning without DMF and acetone makes the reaction in the aerogel incomplete and the presence of impurities leads to the instability of the internal skeleton structure of the aerogel and a serious degradation of the performance thereof.

### Effect Verification

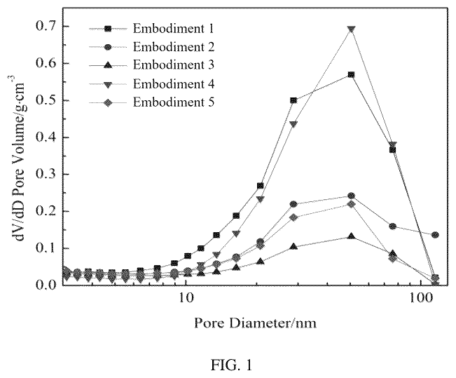

(1) In order to verify the surface properties of the polybenzoxazine aerogel films obtained by the present disclosure, the products of Embodiments 1-5 and Comparative embodiments 1-3 are tested for specific surface area, pore volume, average pore diameter and pore size distribution. The test conditions are as follows: the specific surface area of aerogel is measured by low-temperature N₂ adsorption BET multipoint method, and the samples are heated and vacuum degassed before the test, with the heating temperature of 120° C. and degassing duration of 12 h. TriStarII3020 automatic specific surface area meter (Micromeritics, USA) is selected for the test, and the test results are shown in Table 1 and FIG. 1.

TABLE 1
Surface performance test of aerogel films

| | Specific surface | Pore | Average pore |
|---|---|---|---|
| | area/cm² · g⁻¹ | volume/g · cm⁻³ | diameter/nm |
| Embodiment 1 | 103.59 | 0.374 | 19.161 |
| Embodiment 2 | 69.06 | 0.146 | 11.112 |
| Embodiment 3 | 50.79 | 0.095 | 10.236 |
| Embodiment 4 | 91.69 | 0.337 | 20.587 |
| Embodiment 5 | 75.64 | 0.138 | 11.981 |
| Comparative | 39.55 | 0.074 | 7.952 |
| embodiment 1 | | | |
| Comparative | 49.46 | 0.096 | 9.714 |
| embodiment 2 | | | |
| Comparative | 43.63 | 0.094 | 8.485 |
| embodiment 3 | | | |

As can be seen from the data in Table 1, the polybenzoxazine aerogel film prepared by the present disclosure has good mechanical properties, making it sufficient for applications in heat preservation and heat insulation scenes. Through comparisons between Embodiment 1 and Comparative embodiments 1-3, it can also be seen that the cleaning method designed by the present disclosure is effective in improving the average pore size, specific surface area and other properties of the products.

FIG. 1 shows the pore size distribution of polybenzoxazine aerogel films obtained in Embodiments 1-5. As can be seen from the figure, after heat treatment of aerogels, the comparison between aerogels with different temperature gradients and those at room temperature shows that with the increase of temperature, the density of aerogels increases continuously, and the shrinkage rate of samples also increases gradually, which indicates that the skeleton structure of aerogels begins to strengthen, and the particle size and pore size also begin to increase, mainly between mesopores and macropores. When the temperature rises to 180° C., the microstructure of aerogels is the best.

(2) In order to verify the thermal insulation performance of the polybenzoxazine aerogel film obtained by the present disclosure, the thermal conductivity of the products in Embodiments 1-5 is tested. The thermal conducting efficiency of the aerogel is measured by DRX-II-RW film thermal property tester, which adopts advanced transient heat flow method and longitudinal heat flow technology, and measures a thermal conductivity in the range of 0.015-100 W/MK, with test conditions including: the tested samples are regular shaped, with dimensions of 30 mm in diameter and 0.02-20 mm in thickness, and the temperature range is between room temperature and 200° C. The specimens are sandwiched between two metal blocks during the test, and the test results are shown in Table 2.

TABLE 2
Thermal insulation performance test of aerogel films

| | Embodi- | Embodi- | Embodi- | Embodi- | Embodi- |
|---|---|---|---|---|---|
| | ment 1 | ment 2 | ment 3 | ment 4 | ment 5 |
| Thermal | 0.055 | 0.062 | 0.055 | 0.074 | 0.061 |
| conductivity | | | | | |
| W/(m · K) | | | | | |

As can be seen from the data in Table 2, the thermal conductivity of the product prepared by the present disclosure is generally below 0.074 W/(m·K), which is sufficient for the application in the field of thermal insulation.

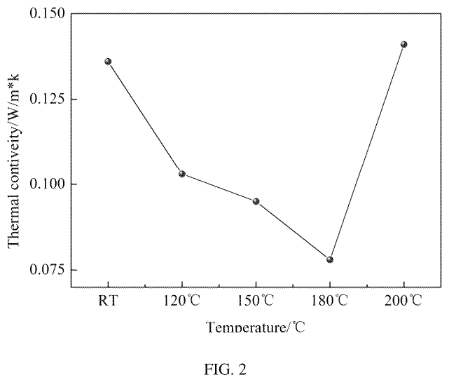

FIG. 2 shows the thermal conductivity curves of polybenzoxazine aerogel films obtained at different heat treatment temperatures. It can be seen from the figure that with the increase of curing temperature, the thermal conductivity of the sample is constantly increasing, mainly in the range of 0.10-0.14 W/(m·K). At higher temperatures, the reticular structure of the sample collapses, the pore structure and reticular structure of the sample are agglomerated, and the skeleton particles are too tightly connected, and the solid-gas heat conduction is changed to solid-solid conduction, the pores in the sample become smaller, and the average molecular free-range decreases, which leads to the increase of thermal conductivity and the rise of the thermal conducting efficiency. Moreover, when the curing temperature is 180° C., the thermal insulation effect is the best.

The above-mentioned embodiments only describe the preferred mode of the present disclosure, and do not limit the scope of the present disclosure. Under the premise of not departing from the design spirit of the present disclosure, various modifications and improvements made by ordinary technicians in the field to the technical scheme of the present disclosure shall fall within the protection scope determined by the claims of the present disclosure.

1. A polybenzoxazine aerogel film, wherein a preparation method of the polybenzoxazine aerogel film comprises:
(1), dissolving 20 parts by mass of benzoxazine monomer in 42 parts of DMF, dissolving 3 parts by mass of 37% hydrochloric acid in 42 parts of DMF, and uniformly mixing the first solution of benzoxazine monomer in DMF and the second solution of hydrochloric acid in DMF to obtain a polybenzoxazine solution;
(2), coating the polybenzoxazine solution onto a ceramic substrate with a thickness of 3 mm by a spin coating method, and standing for 30 min to form a wet gel film; and
(3), aging the wet gel film at 20° C. for 6 h, followed by sequentially washing three times with each of the solvents: DMF, acetone, acetonitrile and N-pentane, each time for 8 h, drying at 25° C. under normal pressure, and performing temperature treatment at 25° C. for 2 h to obtain the polybenzoxazine aerogel film;
wherein a preparation method of the benzoxazine monomer comprises: adding 100 parts by mass of N,N-dimethylformamide and 100 parts by mass of bisphenol F into 60 parts by mass of formaldehyde at 45° C., heating to 80° C. after fully dissolving, adding 75 parts by mass of aniline to react for 5 h, and finally washing with NaOH solution and ethanol for 3 h to obtain the benzoxazine monomer.
